(19) United States
(12) Patent Application Publication
(10) Pub. No.: US 2005/0063008 A1
(43) Pub. Date: Mar. 24, 2005

(54) System and method of processing image data

(76) Inventors: Perry Lea, Boise, ID (US); Justen R. Meltz, Boise, ID (US); Michael Tang, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/669,247

(22) Filed: Sep. 24, 2003

(51) Int. Cl. G06F 15/00

(52) U.S. Cl. 358/1.16; 358/524

(57) ABSTRACT

In one embodiment, a system and method of processing image data in an image forming device is provided. The system can be configured to scan one or more sheets of print media and generate one or more image data pages. The one or more image data pages can be loaded into a memory as each image data page is generated. A first image data page can be copied into a page frame memory from the memory. The first image data page can be transmitted for imaging to an imaging mechanism where the transmitting can occur in parallel with the loading.

### BACKGROUND

Image forming devices, such as color copiers, use a scan and print process that scans a document to be reproduced and then prints an image based on data scanned. Some image forming devices included data processing system architectures configured to store scanned data onto mass storage devices (e.g. hard disks) due to the large size of color image data. For example, one scanned color page having a 600 pixel per inch resolution may be 100 megabytes in size. The scanned data was retrieved from the hard disk and subsequently printed. The disk drive and data busses can at times become saturated during print operations involving large amounts of data. In the event of a paper jam or other printing operation failure, image data might need to be reloaded from the storage device in order to continue the print operation. In the event of a duplicate copy job, image data was replayed from the hard disk. In other words, the storage device and data busses sometimes became a bottleneck in the system of processing image data that could affect performance and slow down processing times.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. The figures may not be drawn to scale.

FIG. 1 is a system diagram of one embodiment of an image forming device.

FIG. 2 is a system diagram of one embodiment of an image forming device which illustrates an example of the process flow of image data between the components of the system.

FIG. 3 illustrates one embodiment of a methodology for loading image data into a memory and processing image data to an imaging mechanism.

FIG. 4 illustrates one embodiment of a methodology for loading image data into an image forming device.

### DETAILED DESCRIPTION OF ILLUSTRATED EMBODIMENTS

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of electromagnetic radiation, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or card, a carrier wave/pulse, or any other medium from which a computer, a processor or other electronic device can read. Signals used to propagate instructions or other software over a network, such as the Internet, are also considered a “computer-readable medium.”

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like. Logic may also be fully embodied as software.

“Signal”, as used herein, includes but is not limited to one or more electrical signals, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system, or other type of executable instructions. It will be appreciated by one of ordinary skill in the art that the form of software may be dependent on, for example, requirements of a desired application, the environment it runs on, and/or the desires of a designer/programmer or the like.

“Unit”, as used herein, includes but is not limited to one or more bits, pages, packets, documents, or other groupings of data, or combinations of these.

“User”, as used herein, includes but is not limited to one or more persons, software, computers or other devices, or combinations of these.

Briefly describing one embodiment of the present system and method, it provides for an image data processing architecture configured to process image data in a manner that may reduce wear on mass storage devices (e.g. hard disk). For example, image data can be selectively stored into an internal memory while the image data is received (e.g. being scanned) and the mass storage device can be used once the internal memory is full. The system can also be configured to perform continuous scanning and transfer of image data while allowing time for an imaging mechanism or engine to initialize and prepare for imaging (e.g. warm up). The system can be configured to process image data to the imaging mechanism in parallel with the scanning process to reduce data bus contention by, for example, having a split bus architecture.

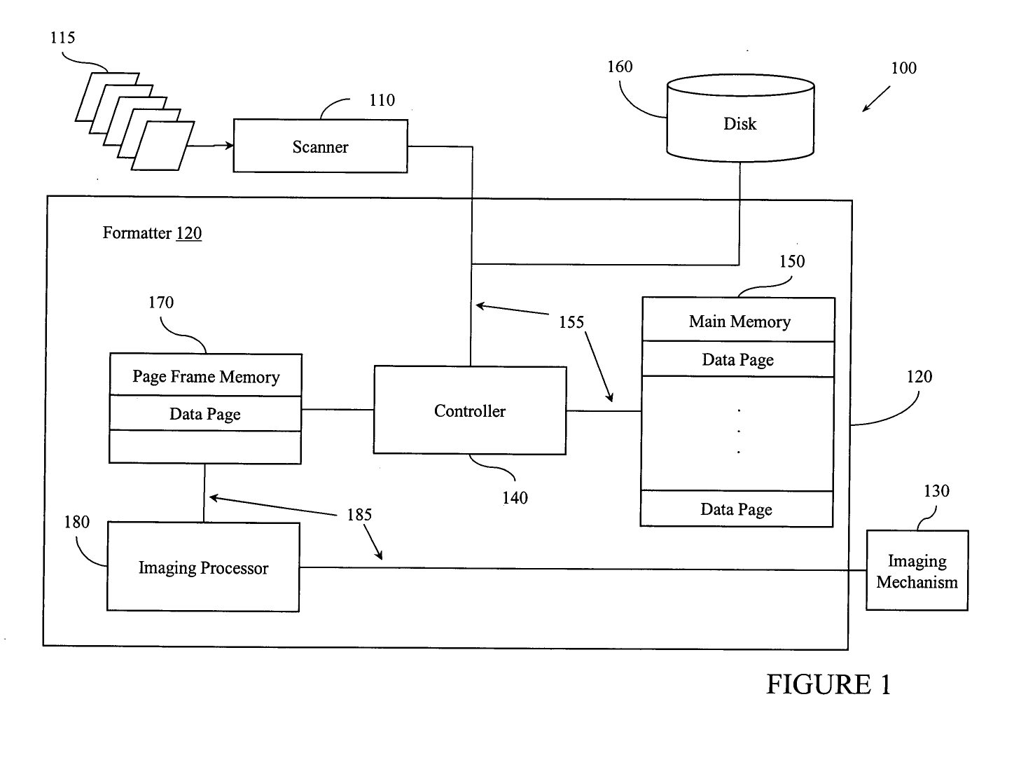

Illustrated in FIG. 1 is a simplified system component diagram of one embodiment of an image forming device 100. Components shown in FIG. 1 generally represent the image forming device 100 in a logical form and may have any desired configuration included within any type of image forming device. For example, the image forming device 100 may be a copier, multi-functional peripheral device, all-in-one product, or other device that can receive image data and print the data onto a print media.

One embodiment of the image forming device 100 can include a scanner 110 configured to scan objects 115, such as pages of print media, and to produce image data representing each scanned page. The scanner 110 may include a copy processor board (CPB) configured to perform a sequence of digital transformations of color and spatial information to format each page of data in a desired manner. Each page can be tuned for quality and compressed, for example, with JPEG, GIF, MPEG, a custom compression technique, or the like. The data pages can then be sent and loaded into a formatter 120 by, for example, a firewire bus or other type of bus using another desired communication protocol. The formatter 120 can be configured to format and process the pages of data before each page is transmitted to an imaging mechanism 130 for printing. For purposes of explanation, image data will be described in terms of pages of data or data pages where each data page represents the electronic version of a single hard copy page. Of course, the image data can be processed in other unit sizes if desired.

In one example, the formatter 120 may include a controller 140 configured to direct the flow of data pages between the components of the formatter 120. The controller 140 may be embodied as logic such as an application specific integrated circuit. For example, the controller 140 can be configured to act as a processor interface to memory, to initiate a PCI bus, to compress and decompress data, to control other components such as a control panel, input/output devices, timers, and/or other functions of the image forming device 100.

In one embodiment, the formatter 120 includes a main memory 150 configured to store pages of image data received from the scanner 110. As data pages are generated by the scanner 110, the data pages are loaded into the memory 150 via a data bus 155. The main memory 150 may be embodied as a random access memory (RAM). It will be appreciated that although the bus 155 is logically illustrated to pass through the controller 140, data pages can be communicated directly from the scanner 110 to the main memory 150 without intervention from the controller 140.

With further reference to FIG. 1, the main memory 150 can be configured with an internal storage capacity selected to accommodate a desired capacity. For example, suppose the image forming device 100 includes a paper path that can contain seventeen (17) sheets of print media. The memory 150 can be sized to hold at least seventeen (17) pages of data. In this manner, if a paper jam occurs, one or more sheets in the paper path can be re-printed from its corresponding data page stored in the memory 150. Once the memory 150 is full and additional pages are still being scanned in, a storage device 160 such as a hard disk drive can be included to store the additional data pages. Maintaining more data pages within the main memory 150 can increase processing times since data is communicated faster from a memory as compared to a disk storage device 160. Limiting the use of the storage device 160 as overflow storage also reduces wear on the storage device 160.

The controller 140 can be configured to maintain a data page in the memory 150 until the data page is safety printed and outputted, which will be described in more detail below. It will be appreciated that terms such as “store,” “storage,” “load,” “hold,” and “maintain” used herein may refer to data processing actions with storage devices for long term storage (e.g. mass storage devices such as CD-ROM, disk, and like) as well as with memory devices for short term buffering (e.g. internal memory areas such as RAM, DRAM, and the like).

Prior to storing each data page in the main memory 150, the data page can be compressed to optimize the storage capacity. For example, a typical scanned color page can result in an uncompressed data page of 105 megabytes (MB). To increase system performance, the scanned data can be compressed prior to processing the data through the formatter 120. For example, a compression algorithm can be used to achieve a desired compression ratio like a 5:1 ratio, but other compression ratios can be used as desired. Using a compression ratio of 5:1, a 105 MB color page can be reduced to a size of 21 MB after compression. Therefore, if the main memory 150 has a size of 448 MB, it would be capable of storing 21.33 pages or units of image data. It will be appreciated that as the compression ratio is increased, the possibility of ghosting and other natural occurrences in the image data can occur.

With further reference to FIG. 1, the formatter 120 may also include a page frame memory 170 configured to hold individual pages of image data in preparation for imaging to the imaging mechanism 130. In one embodiment, the page frame memory 170 can be configured to hold the next data page to be printed where data pages are sequentially copied from the memory 150 by, for example, direct memory access (DMA). Once the data page is printed, the data page can be released from the page frame memory 170 and the next data page is copied in from the memory 150.

The page frame memory 170 can be configured with a selected capacity to ensure that the largest sized page of data can be stored without relocation issues. For example, in one embodiment, the page frame memory 170 may be 64 MB which would allow for a single compressed page of complex color image data to be stored. It will be appreciated that the capacity of the page frame memory 170 may be altered or expanded to accommodate different page size requirements. For example, it will be appreciated that the capacity of the page frame memory 170 may be increased in order to allow the page frame memory 170 to store pages with higher memory requirements (e.g. pages with higher resolutions), and/or multiple pages of image data.

Additionally, the formatter 120 may also include an imaging processor 180 configured to process the data page from the page frame memory 170, convert the data page to a print engine ready format, and transmit the converted data page to the imaging mechanism 130 when it is ready for printing. In one embodiment, the imaging processor 180 can include one or more ASIC chips configured to process a selected plane of color data. For example, three video ASIC chips can be provided to process red, blue, and green color planes, respectively. Of course, other configurations can be implemented such as a single logic component programmed to process all selected color planes.

When the imaging mechanism 130 is ready to accept the next data page, the imaging processor 180 can decompress the data page, convert it to engine ready data (e.g. pulse modulated wave patterns), and transmit the engine ready data to the imaging mechanism 130 to perform the printing. In one embodiment, the engine ready data is streamed to the lasers. It will be appreciated that the format of the engine ready data, also called print-ready data, may be different based on the type of imaging mechanism used. In general, engine ready data is data that can be interpreted and processed by the imaging mechanism 130.

To accomplish the transmission of data between the page frame memory 170 and the imaging mechanism 130, the formatter 120 is configured with at least a second bus 185 that is independent from the bus 155 used to communicate data between the scanner 110 and the main memory 150. Thus in one embodiment, the formatter 120 includes a split bus or dual bus system where the busses can communicate data simultaneously in parallel. This configuration allows the image forming device 100 to continuously scan pages and load them into the memory 150 while the first data page is loaded into the page frame memory 170 and waits until the imaging mechanism 130 warms up. When the imaging mechanism 130 is ready to print, the data page can be transmitted from the page frame memory 170 to the imaging mechanism 130 in parallel with the data pages being loaded into main memory 150. Thus, bus contention and data communication interruptions can be reduced and response times can be increased.

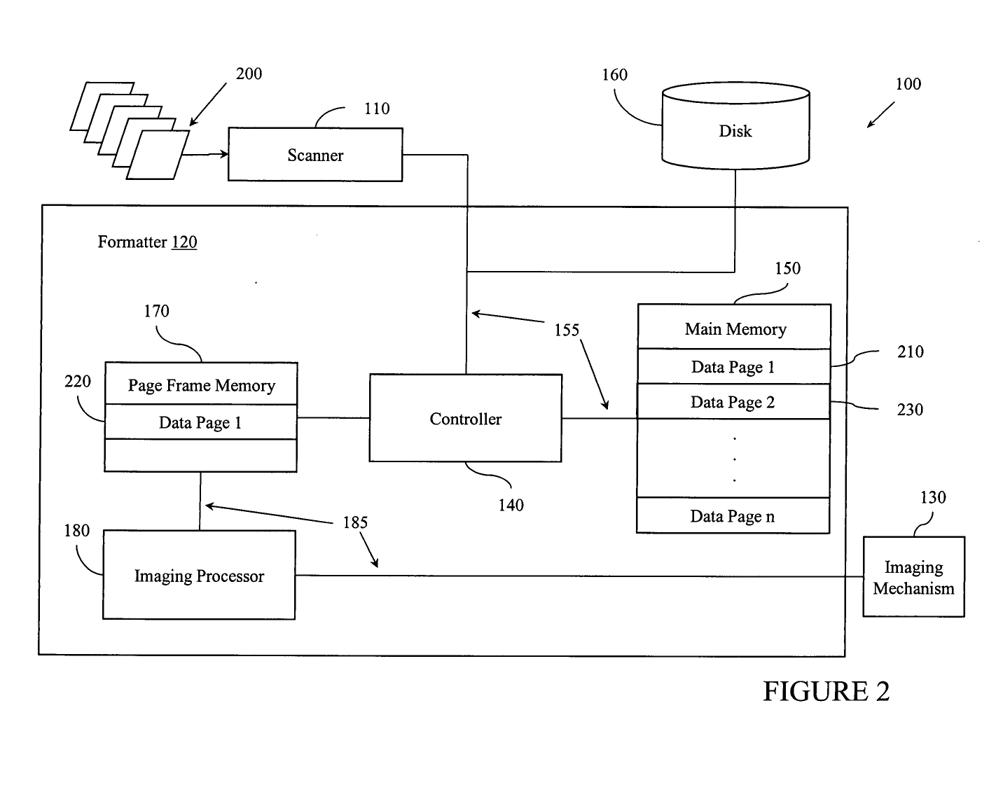

In one example, the dual bus configuration can include a first data bus configured to communicate the image data between the scanner 110, the main memory 150, the disk 160, the controller 140, and the page frame memory 170. A separate second data bus can be configured to communicate image data between the page frame memory 170, the imaging processor 180, and the imaging mechanism 130. It will be appreciated that any number and configuration of data busses may be used to accommodate desired functions or preferences. The operation and directional flow of the image data will be further explained with reference to FIG. 2.

Illustrated in FIG. 2 is an example of image data flow through the image forming device 100, and more specifically, through the formatter 120. The components illustrated generally exemplify the image forming device 100 and may have other arrangements. As one example, a first page of media 200 can be scanned by the scanner 110 creating image data and the data can be compressed. Once compressed, the image data can be streamed over a firewire bus to the formatter 120 for processing. Of course, other communication connections and/or protocols can be used. It will further be appreciated that image data may be received from other sources in lieu of the scanner 110. For example, image data may be received from a remote device that transmits the image data to the image forming device 100.

Initially upon entry into the formatter 120, the data page can be temporarily held in an input/output buffer before being transferred into the memory 150. For example, the first page (data page 1) of image data can be transferred by the controller 140 to and buffered into a location 210 within the main memory 150.

Once the first page of image data is buffered into location 210, a copy of the data page 1 can be sent and buffered into a location 220 within the page frame memory 170 where the data is staged to be printed. It will be appreciated that a direct memory access (DMA) transfer technique may be used to transfer the data pages from the main memory 150 to the page frame memory 170. It will further be appreciated that an interleaving technique may be used to populate the page frame memory 170 in lieu of transferring the data from the main memory 150. In other words, for example, the system can be configured to send specific pages of image data directly to the page frame memory 170 from the scanner 110 while sending alternate pages to the main memory 150 for storage and subsequent transfer to the page frame memory 170.

In order to facilitate continuous uninterrupted processing of image data, the system can be configured to utilize a “jam store” technique. In other words, a copy of the data page can be retained in the main memory 150 until the imaging process for the data page is successfully completed. The retention of a copy of the data page 1 in location 210 enables the system to readily access and reload the data page 1 into the page frame memory 170 in the event that a jam or other error occurs while printing the data page 1.

Concurrent with the processing of the data page 1, additional pages of image data can be scanned and buffered into main memory 150. For example, a second page of scanned image data (data page 2) can be sent to and buffered in a location 230 of the main memory 150. This scanning, buffering and transferring process can continue simultaneously with the processing and subsequent printing of the data page from the page frame memory 170. The system can be configured to continue this process until all pages of a document are scanned or until the main memory 150 is filled to capacity.

In the event that the main memory 150 is filled to capacity (e.g. is loaded with data page n, the controller 140 can be configured to direct overflow data pages to the disk 160 for storage and later retrieval. In other words, if the capacity of main memory 150 is reached upon storing the tenth page of a document, the system can be configured to direct the eleventh page of image data to the disk 160 for storage. Imaging tasks that contain a large number of pages, complex pages, and those requiring duplicate prints are examples of tasks where the required memory may exceed the memory available. In each case, the data can be DMA copied to the disk 160 for later retrieval and imaging.

Although, saving to disk 160 is described in accordance with the saturation of the main memory 150, it will be appreciated that the system can direct image data to disk 160 in accordance with specific applications or preferences. For example, the system can interleave pages to disk by sending alternate pages between the main memory 150 and the disk 160 to accommodate a specific task. It will be appreciated that the disk 160 may be replaced by any computer-readable medium capable of storing image data.

Referring again to the example, the data page 1 is maintained in the page frame memory 170 until the imaging mechanism 130 is prepared to print the page (e.g. is warmed up). The imaging processor 180 (e.g. video ASIC) can decompress the data page 1 and convert it to engine ready data. Once the imaging mechanism 130 has completed initialization and is ready to print, the imaging processor 180 can transmit the engine ready data to the imaging mechanism 130 for imaging. As explained previously, this transmission can occur in parallel with the data pages being loaded into the memory 150 since two separate busses 155, 185 are used. After successful transmission to the imaging mechanism 130, the buffer location 220 within the page frame memory 170 can be released and available to accept the next data page (e.g. data page 2) from the memory 150 and the process repeats.

Furthermore, as previously mentioned in accordance with the “jam store”, the pages of image data are retained in the main memory 150 until a corresponding hard copy page is printed and outputted. Upon successful completion of imaging, the data page 1 can be released from the main memory 150 allowing the location 210 to be used to buffer an additional page of image data. However, in the event that an error or jam occurs before its hard copy page is outputted, the controller 140 can replay the corresponding data page retained in the main memory 150. For example, if a jam is detected while printing the data page 2, the controller 140 can resend the data page 2 from the main memory 150 to the page frame memory 170 to prepare for resuming the printing process.

If pages of image data are contained in the disk 160 and an error or jam occurs, it will be appreciated that the system can be configured to use the data saved to the disk 160 in the same manner as described above. In other words, if an error occurs while printing page eleven which is saved on the disk 160, the system can replay page eleven and transfer the data page to the page frame memory 170. Subsequently, the image data representing page eleven can be sent to the imaging mechanism 130 for printing. Additionally, upon successful completion of an imaging task, the system can be configured to delete image data saved to the disk 160 making additional space available for storage of subsequent pages.

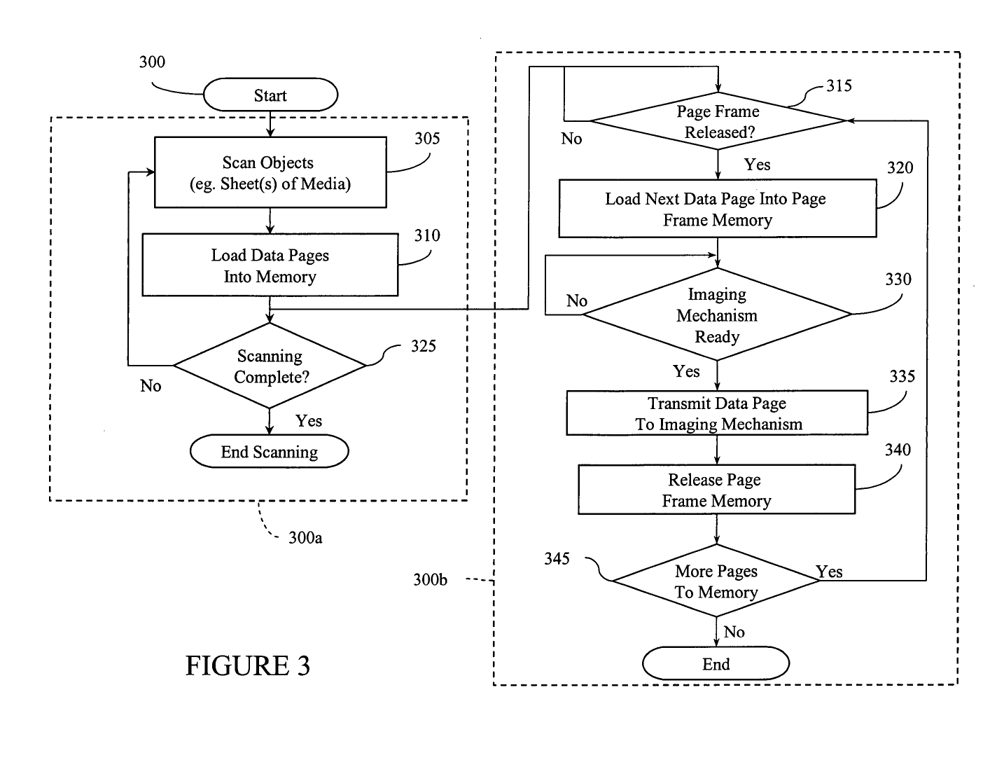

Illustrated in FIG. 3 is one embodiment of a methodology 300 associated with an image data processing system. The illustrated elements denote “processing blocks” and may represent logic instructions or groups of instructions that cause a computer, processor, or other logic component to perform an action(s) and/or to make decisions. Alternatively, the processing blocks may represent functions and/or actions performed by functionally equivalent circuits such as a digital signal processor circuit, an application specific integrated circuit (ASIC), other logic device, or combination of logic devices. The diagram, as well as the other illustrated diagrams, do not depict syntax of any particular programming language. Rather, the diagram illustrates functional information one skilled in the art could use to fabricate circuits, generate software, design an electronic device, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. They may also be implemented using various programming approaches such as machine language, procedural, object oriented and/or artificial intelligence techniques. The foregoing applies to all methodologies described herein.

With reference to FIG. 3, the methodology 300 will be described with reference to an image data processing system for an image forming device. In the example, the methodology will be described with reference to a copier but will also apply to other devices that include a scanning device that generate image data from a scanned object. It will be appreciated that the scanning device serves as an input mechanism and that the image data can be received from other input mechanisms such as a remote computer that transmits the image data to the image forming device for printing. The methodology 300 will also be described with reference to an image data processing system that includes a main memory, a page frame memory, one or more processors, and at least a dual bus configuration that allows parallel data communication between components of the system. The methodology will also be described in terms of two processes, a scanning process 300a and an imaging process 300b, where one or more portions of each can be occurring concurrently.

With reference to FIG. 3, the process may begin upon a request to scan one or more objects such as sheets of paper (Block 305). Each sheet is scanned and an image data page is generated in digital form representing the scanned page. The data page is then loaded into memory (Block 310). If this is the first page scanned, the data page is also loaded into a page frame memory. A check can be made to determine if the page frame memory is released and available to accept a new data page (Block 315). If released, the data page is copied from the memory and loaded into the page frame memory (Block 320). This part of the imaging process 300b then waits until the imaging mechanism is ready for printing. With the first loaded page, the imaging mechanism may need to initialize and warm up. While the imaging process 300b waits, the scanning process 300a can continue simultaneously. At Block 325, if scanning is not completed yet, the process continues with scanning and loading of additional data pages (Blocks 305, 310, respectively).

Referring to the imaging process 300b at Block 330, the process determines when the imaging mechanism is ready to print the next page (e.g. initialized and warmed up if the first page). Once the mechanism is ready, the data page from the page frame memory is transmitted to the imaging mechanism (Block 335) which can occur in parallel with the loading of data pages into memory. Once the data page is successfully transmitted, the data page can be released from the page frame memory allowing the next data page to be loaded from memory (Block 340). If there are more pages to be imaged (Block 345), the imaging process 300b repeats with Block 315. Once the page frame memory is released, the next data page can be loaded from the memory (Block 320) and the process continues.

As previously described, the data pages from the page frame memory can be transmitted to the imaging mechanism in parallel with the data pages being loaded into memory during scanning. In one embodiment this is implemented with a dual bus configuration where separate data buses are used. This can reduce delays in data communication and reduce potential bus contention issues.

Referring again to the methodology 300 at block 310, additional steps can be performed. For example, the image data can be tuned for quality and compressed before being stored in the main memory. At Block 335, the methodology can include additional steps. For example, prior to transmitting the data page to the imaging mechanism, the data page can be decompressed and converted to a print-ready format that is processable by the imaging mechanism.

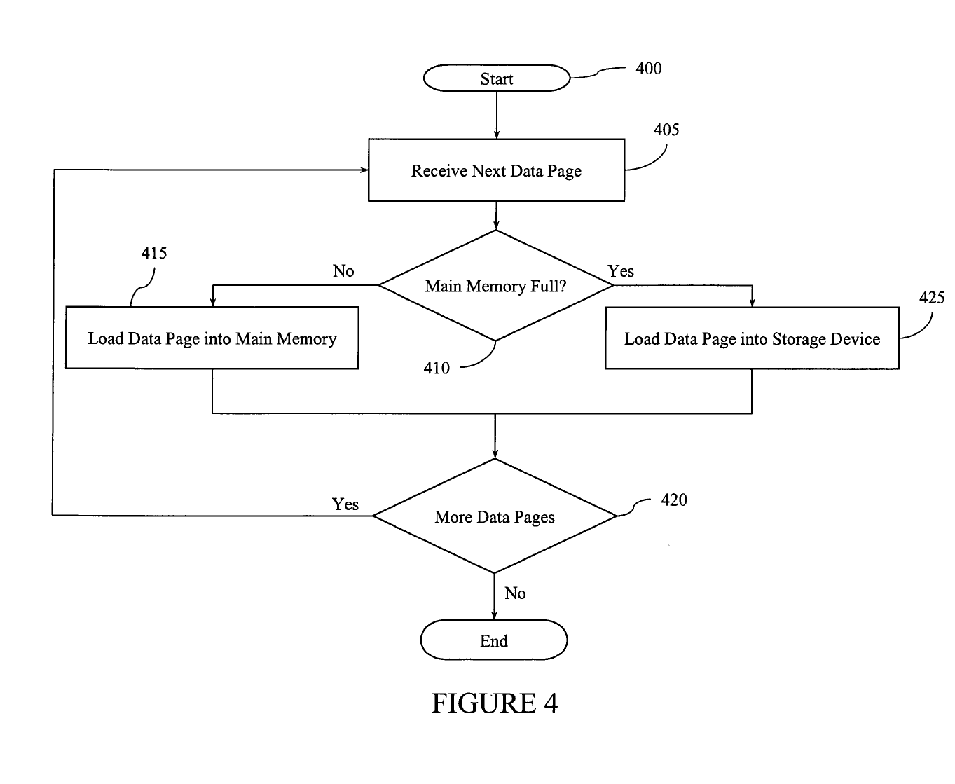

Illustrated in FIG. 4 is a methodology 400 associated with receiving and storing data pages into an image data processing system. For example, each data page can be received from a scanning device or other electronic device. The methodology begins by receiving a data page (Block 405) that represents image data of an associated object such as a sheet of paper. A main memory is then checked to determine if it is full (Block 410). If the main memory is not full, the data page is loaded into the main memory (Block 415). If there are more data pages at Block 420, the process returns to receive the next data page. If the main memory is full at Block 410, the next data page is then loaded into a storage device such as a disk drive (Block 425). If there are more data pages at Block 420, the process returns to receive the next data page and continues.

In this manner, image data pages are initially loaded into a main memory and then a storage device is used as an overflow device once main memory is full. The speed of data processing can be increased since input/output processing from a memory device is faster than from a storage device. Furthermore, wear on the storage device can be reduced.

Once all of the data pages of a job are loaded into the system, whether all in main memory, or part in main memory and part in the storage device, the imaging mechanism can print each data page sequentially unless different printing instructions are provided. During printing, the system can be configured to maintain a selected number of data pages in main memory until it is determined that those data pages are successfully printed and outputted by the image forming device. Thus, as previously described, in case of a paper jam or other printing error, data pages not successfully outputted can be reloaded into the page frame memory from the main memory. Once a data page is successfully printed and outputted, its memory location in the main memory can then be released to accept additional data pages. This can also be performed when duplicate copy requests are being processed. For example, the data pages can be maintained in main memory until the duplicate and/or multiple copy requests for a data page are completed. If the main memory cannot accommodate all of the data pages in a copy request, the overflow pages can be stored in a storage device.

The example embodiments describe an image forming device and a image formatter or image data processing system configured with multiple internal data storage areas (e.g. memory). It will be appreciated that the present system and method can also be configured to use a single internal memory that can be partitioned into a main memory and a page frame memory as described above. It will further be appreciated that although sequential page imaging is described in some of the examples, other imaging arrangements may be used such as collated imaging, reverse-order imaging, and others.

Suitable software for implementing the various components of the present system and methods using the teachings presented here include programming languages and tools such as Java, Pascal, C#, C++, C, CGI, Perl, SQL, APIs, SDKs, assembly, firmware, microcode, and/or other languages and tools. The components embodied as software include computer readable/executable instructions that cause one or more computers, processors and/or other electronic devices to behave in a prescribed manner. Any software or firmware, whether an entire system or a component of a system, may be embodied as an article of manufacture and maintained as part of a computer-readable medium as defined previously. Another form of the software may include signals that transmit program code of the software to a recipient over a network or other communication medium. It will be appreciated that components described herein may be implemented as separate components or may be combined together.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. An image forming device comprising:
a scanner configured to scan one or more objects and generate image data representing each of the one or more objects;
a memory configured to store each of the image data as a page of data;
a page frame buffer configured to store a page of data, copied from the memory, that is to be imaged;
an imaging mechanism configured to receive the page of data from the page frame buffer and generate an image from the page of data onto a print media; and
a dual bus system configured to allow parallel transmission of data where the image data can be transmitted from the scanner to the memory simultaneously with transmitting the page of data from the page frame buffer to the imaging mechanism.

2. The device of claim 1 where the dual bus system includes a first bus configured to communicate data between the scanner and the memory, and a second bus configured to communicate data between the page frame memory and the imaging mechanism.

3. The device of claim 2 where the first bus is configured to allow image data to be loaded into the memory independent of transmitting data from the page frame memory to the imaging mechanism.

4. The device of claim 2 further comprising:
a first processor configured to control communication of the image data to the memory; and
a second processor configured to control communication of the page of data from the page frame memory to the imaging mechanism.

5. The device of claim 4 where the second processor is configured to decompress the page of data and transmit pulse modulated wave patterns to the imaging mechanism based on the decompressed page of data.

6. The device of claim 4 where the first and second processors include application specific integrated circuits.

7. The device of claim 1 where the page frame buffer is configured to store one or more pages of data as one or more units.

8. The device of claim 1 where the dual bus system is configured to communicate data by direct memory access.

9. The device of claim 1 further including a storage device configured to store image data from the scanner once the memory is full.

10. The device of claim 1 where the page of data includes at least three planes of color data.

11. A method of processing image data in an image forming device, the method comprising:
scanning one or more sheets of print media and generating one or more image data pages;
loading the one or more image data pages into a memory;
copying a first image data page into a page frame memory from the memory to prepare for imaging; and
transmitting the first image data page for imaging to an imaging mechanism where the transmitting can occur in parallel with the loading.

12. The method of claim 11 further including converting the first image data page into print ready data before transmitting for imaging.

13. The method of claim 11 further including holding the first image data page in the page frame memory until the imaging mechanism is ready to print.

14. The method of claim 11 further including loading one or more image data pages into a mass storage device once the memory is full.

15. The method of claim 11 further including removing an image data page from the memory after the image data page has been imaged and outputted from the image forming device.

16. The method of claim 11 further including sequentially copying the one or more image data pages from the memory to the page frame memory to prepare for imaging.

17. A system for formatting image data for an image forming device, the system comprising:
a first data bus;
a first memory configured to store image data pages, the first memory being configured to receive the image data pages over the first data bus;
a second memory configured to load a page of data that is to be imaged, the page of data being received from the first memory; and
a second data bus configured to communicate the page of data from the second memory to an imaging mechanism where the page of data can be transmitted to the imaging mechanism in parallel with the first memory receiving the image data pages.

18. The system as set forth in claim 17 further including an imaging processor configured to process the page of data from the second memory into print ready data that can be processed by the imaging mechanism.

19. The system as set forth in claim 18 where the imaging processor includes one or more logic circuits each configured to process one plane of color data from the page of data.

20. The system as set forth in claim 17 where the first data bus is in data communication with a scanning device configured to scan objects and generate a image data page including color data representing each scanned object.

21. The system as set forth in claim 17 further including a storage disk device configured to store overflow image data pages after the first memory is at capacity.

22. The system as set forth in claim 17 where the system is configured to copy an image data page from the first memory to the second memory by direct memory access.

23. The system as set forth in claim 17 where the system is configured to process image data pages as one or more data units.
